(19) United States
(12) Patent Application Publication
(10) Pub. No.: US 2006/0176597 A1
(43) Pub. Date: Aug. 10, 2006

(54) Programmable write head drive de-gaussing circuit

(76) Inventors: Tuan Van Ngo, Eden Prairle, MN (US); Craig Matthew Brannon, Maplewood, MN (US); John Joseph Price JR., Eagan, MN (US)

Correspondence Address: TEXAS INSTRUMENTS INCORPORATED, P O BOX 655474, M/S 3999, DALLAS, TX, 75265, US

(21) Appl. No.: 11/052,381

(22) Filed: Feb. 7, 2005

(51) Int. Cl. G11B 5/09; G11B 5/02

(52) U.S. Cl. 360/46; 360/68

(57) ABSTRACT

A write head drive circuit for a magnetic data storage device is configured to drive a write head with a write head degaussing current that is applied at the end of a write cycle. The write head degaussing current is an alternating current waveform with a programmable number of current pulses with decreasing amplitude and a frequency controlled by a CMOS ring oscillator. The CMOS ring oscillator includes switchable feedback paths to control its frequency. A programmable timer terminates the write head degaussing current after an interval of time dependent on signals that indicate the programmable number of current pulses and the frequency of the CMOS oscillator.

### CROSS REFERENCE TO RELATED APPLICATIONS

The following U.S. patents and/or commonly assigned patent applications are hereby incorporated herein by reference:

| Patent or | | | Attorney |
|---|---|---|---|
| Serial No. | Filing Date | Issue Date | Docket No. |
| 6,798,591 | Oct. 29, 2001 | Sep. 28, 2004 | |
| 6,735,030 | Oct. 29, 2001 | May 11, 2004 | |
| 10/753,691 | Jan. 8, 2004 | | TI-36216 |
| 10/786,967 | Feb. 25, 2004 | | TI-36208 |
| 10/249,665 | Apr. 29, 2003 | | TI-34499 |
| 10/360,503 | Feb. 6, 2003 | | TI-34938 |
| 10/407,011 | Apr. 3, 2003 | | TI-34398 |
| 10/234,261 | Sep. 4, 2002 | | TI-34122 |
| 10/754,647 | Jan. 10, 2004 | | TI-34076 |
| 10/179,561 | Jun. 25, 2002 | | TI-33850 |
| 10/002,193 | Oct. 19, 2001 | | TI-31786 |
| 09/974,281 | Oct. 9, 2001 | | TI-31785 |

### TECHNICAL FIELD

Embodiments of the present invention relate generally to the field of mass media information storage devices, and more particularly to programmably controlling the write current for a thin-film write head.

### BACKGROUND

Hard disk drives are mass data storage devices that include a magnetic storage medium, e.g. rotating disks or platters, a spindle motor, read/write heads, an actuator, a preamplifier, a read channel, a write channel, a servo circuit, and control circuitry to control the operation of the hard disk drive and to properly interface the hard disk drive to a host system or bus to exchange data. The data are represented as magnetic flux transitions on the magnetic platters, with each platter coupleable to a read head that transfers data to a preamplifier during a read operation, and to a write head that transfers data to the magnetic medium using a magnetic coil during a write operation. The preamplifier is coupled to a synchronously sampled data (SSD) channel comprising a read channel and a write channel, and a control circuit. The SSD channel and the control circuit are used to process data being read from and written to the platters, and to control the various operations of the hard disk mass storage system. The host exchanges data employing a control circuit. Additional details describing magnetic mass data storage systems are contained in U.S. Pat. No. 6,735,030 by Ngo et al., and U.S. Pat. No. 6,798,591 by Barnett et al., which are hereby incorporated herein by reference.

The data are usually stored and retrieved from each side of the magnetic platters which, for very high density data storage, are generally formed as very flat and highly polished glass disks overlaid with a vacuum-sputtered multilayer magnetic film. The magnetic film is usually ferromagnetic alloy layers separated by a very thin ruthenium layer and then overlaid with a lubricating film that may be only several molecules thick. A conventional write head comprises a thin-film write coil to couple a highly localized magnetic field to the magnetic medium and a conventional read head comprises a magneto-resistive strip for a read sensor. The write coil is adapted to write data to the magnetic medium when a current is passed through it. The magneto-resistive strip providing the read function is coupled to a preamplifier that serves as an interface between the read/write heads of the disk/head assembly and the SSD channel. The preamplifier provides amplification to the read waveform data signals as needed. The head assembly floats on a cushion of air that may be less than 10 microinches thick, and transfers data to the magnetic medium at a data rate that may be of the order of a GHz. The resulting bit density on one side of a platter is approaching and may soon exceed 5·10¹¹ bits per square inch.

A consequence of the very small dimensions associated with the magnetic medium and the head assembly is very small read signal levels. To insure reliable read data it is necessary to reduce or eliminate any noise-contributing elements in the process. One noise contributing element is random magnetic domain relaxations in the magnetic structure of the write coil after a write operation. The write coil employs substantial magnetizing currents to form the recorded bits as flux transitions in the magnetic medium. After the magnetizing current in the write coil is disabled, magnetic domain relaxations from residual magnetism in the write coil magnetic medium are sensed as they snap back during a subsequent read operation from trapped magnetic states to random orientations. These magnetic domain relaxations generate data-interfering signals in the very sensitive magneto-resistive read element, which is physically very close to the write coil. The read head and the read amplifiers are scaled to sense very small signals from the magnetic transitions on the disk. Thus it is a general objective to produce a neutral bulk magnetization state for the write head after a write operation.

A particular area for improvement of write-driver current circuits used to drive a thin-film write coil includes providing a write current waveform to demagnetize the magnetic element of the write coil after a write operation. In recording a data sequence onto a magnetic disk, an empty “gap” or buffer zone is left at the end of the recorded data in a data track on the surface of the disk. In this buffer zone current can be coupled to the write coil without corrupting data already on the disk and without interfering with a following read operation. Accordingly, there is desired an improved write current driver circuit which can provide current for a write coil that can demagnetize the magnetic element of the write coil after a write operation so that subsequent magnetic domain relaxations can be reduced, thereby reducing or eliminating a noise source that can interfere with a read operation. In particular, such a write current driver circuit would advantageously be implemented without introducing substantial power losses or circuit complexity, thereby preserving cost competitiveness of these products in large consumer and industrial markets.

### SUMMARY OF THE INVENTION

In one aspect, the present invention relates to utilizing a write head drive circuit for a magnetic data storage device configured to selectively drive a write head either with a current signal representing data to be stored or with a write head degaussing current that is applied at the end of a write cycle. A write head degaussing current is generally a high-frequency alternating current waveform with a programmable number of current pulses with decreasing amplitude. In response to the need to provide a control circuit with few circuit elements and low power consumption, a programmable timer is configured to terminate the degaussing current in the write head so that the desired number of current pulses is coupled to the write head coil.

Embodiments of the present invention achieve technical advantages by configuring a write head drive circuit to produce a write head degaussing current comprising an alternating current waveform of pulses, and terminating the write head degaussing current in response to a programmable timer. The write head drive circuit includes a high-frequency signal source that determines the frequency of the alternating current waveform. The amplitude of the write head degaussing current is preferably controlled with a substantially exponentially decreasing current waveform. The high-frequency signal source may have a programmable frequency. Preferably, the high frequency signal source is a CMOS ring oscillator, and preferably, the CMOS ring oscillator utilizes at least one switchable feedback path to control its frequency. The circuit terminates the write head degaussing current in response to a programmable timer after an interval of time dependent on a signal indicative of the programmable number of current pulses. Preferably, the programmable number of current pulses is between 3 and 16. And preferably, the interval of time is dependent on another signal indicative of the frequency of the high-frequency signal source. By including a programmable timer to indicate when to terminate the write head degaussing current, a control circuit with few circuit elements and low power dissipation can be configured, thereby enabling a low cost and low power design.

Another embodiment of the present invention is a mass data storage device configured with a write head drive circuit to produce a write head degaussing current comprising an alternating current waveform of degaussing pulses, and terminating the write head degaussing current with a programmable timer. The write head drive circuit includes a high-frequency signal source that determines the frequency of the alternating current degaussing waveform. The amplitude of the write head degaussing current is preferably controlled with a substantially exponentially decreasing current waveform. The high-frequency signal source may have a programmable frequency. Preferably, the high frequency signal source is a CMOS ring oscillator, and preferably, the CMOS ring oscillator utilizes at least one switchable feedback path to control its frequency. The programmable timer terminates the write head degaussing current after an interval of time dependent on a signal indicative of the programmable number of current pulses. Preferably, the programmable number of current pulses is between 3 and 16. And preferably, the interval of time is dependent on another signal indicative of the frequency of the high-frequency signal source. By including a programmable timer to terminate the write head degaussing current in a mass data storage device, a control circuit with few circuit elements and low power dissipation can be configured, thereby enabling a low cost and low power design.

Another embodiment of the present invention is a method of configuring a write head drive circuit with a write head degaussing current that generates an alternating current waveform of pulses that is terminated with a programmable timer. The method includes terminating the write head degaussing current after an interval of time dependent on a signal that indicates a programmable number of alternating current pulses. The method includes providing a high-frequency signal source to determine the frequency of the alternating current waveform. The method further preferably includes controlling the amplitude of the write head degaussing current with a substantially exponentially decreasing current waveform. The method further preferably includes configuring the high-frequency signal source with a programmable frequency. Preferably, the method preferably includes setting the programmable timer to utilize between 3 and 16 degaussing current pulses. The method further preferably includes providing a CMOS ring oscillator for the high frequency signal source, and preferably utilizing at least one switchable feedback path in the CMOS ring oscillator to control its frequency. Preferably, the interval of time is dependent on another signal indicative of the frequency of the high-frequency signal source. By including a programmable timer to terminate the write head degaussing current, a method of configuring a control circuit with few circuit elements and low power dissipation can be performed, thereby enabling a low cost and low power design.

Embodiments of the present invention achieve technical advantages as a write head drive circuit producing an alternating current degaussing waveform with decreasing amplitude and terminated by a programmable timer, thereby enabling an economical and low power circuit with few components.

### BRIEF DESCRIPTION OF THE DRAWINGS

For a more complete understanding of the present invention and the advantages thereof, reference is now made to the following descriptions taken in conjunction with the accompanying drawings, in which:

FIG. 1 illustrates a block diagram of a write head current drive circuit wherein current in an inductive write head is controlled with a programmable timer to degauss the write head after a write operation;

FIG. 2 illustrates a simplified schematic drawing of a circuit that provides an exponentially decaying current waveform to demagnetize a write head;

FIG. 3 illustrates a simplified schematic drawing of a circuit that selectively couples write data or an oscillator output waveform to a write head drive circuit;

FIG. 4 illustrates typical waveforms of write data, a write gate signal, and a write current degaussing signal;

FIG. 5 illustrates a typical write current output decay waveform;

FIG. 6 illustrates simulation results of a write head current and a Read_notWrite signal; and

FIG. 7 illustrates a laboratory measurement of a write degaussing current waveform.

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

Embodiments of the present invention will be described with respect to preferred embodiments in a specific context, namely a write head degaussing circuit in which a programmable timer is used to control the number of current pulses applied to a write head to perform a degaussing function. The invention may be applied to a degaussing circuit in which an exponentially decaying current is utilized to degauss the write head, resulting in write head current pulses with alternating sign and sequentially decaying amplitude.

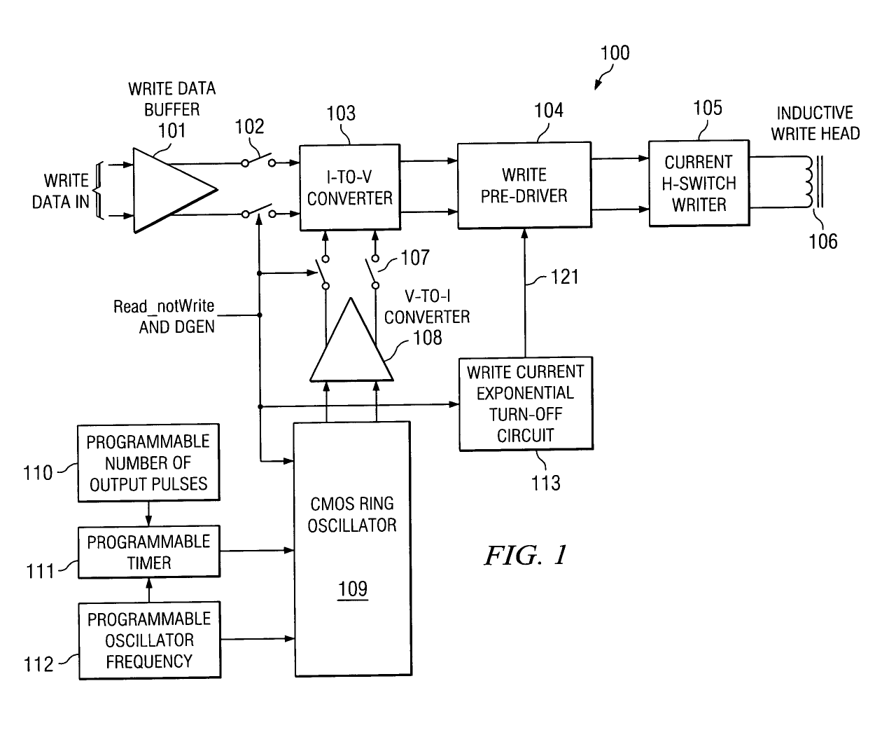

Illustrated in FIG. 1 and shown generally as the circuit 100 is a general block diagram of the present invention in which, during a normal write operation, input write data, which may be differential input data, is coupled to a write data buffer 101. The write data buffer 101 converts the differential data input to a differential current output. The differential output is coupled to the current-to-voltage converter circuit 103 through switches 102, producing a differential voltage output from the block 103. The differential voltage output in turn is coupled to a write pre-driver 104, that buffers the write data signals and conditions the signal to provide signal overshoot as necessary. The pre-driver 104 output is coupled to a current H-switch writer 105 that switches the write current through an external connection to a thin-film transducer in the inductive write head 106. The inductive write head produces the localized magnetized regions in the magnetic medium on the platter representing the stored data, and is generally an inductive circuit element generally consisting of a thin-film coil encircling a gapped ferromagnetic core.

After a data sequence is written to the disk and before a read operation is performed, while the write/read heads are over a buffer area separating data sequences, an exponentially decaying current 121 produced in block 113, controlled by the signals Read_notWrite and DGEN that indicate respectively a “read-not-write” and “degauss enable” operation, is fed to the Write Pre-Driver 104. A CMOS ring oscillator 109 is enabled by the signals Read_notWrite and DGEN and generates a switched voltage waveform on oppositely poled signal lines that is coupled to a CMOS-ECL voltage-to-current converter 108 that provides a current signal, also on oppositely poled lines. The output of the converter 108 is coupled to the current-to-voltage converter 103 through the switches 107.

The switches 102 and 107 are controlled by the signals Read_notWrite and DGEN. If both signals are both low indicating execution of a write operation and disabling of degaussing, the switches 102 are closed, coupling the write data to the circuit driving the inductive write head. When the Read_notWrite and DGEN signals are both high, the switches 107 are closed and the CMOS ring oscillator and the write current exponential turn-off circuit are enabled to perform the degaussing function. In any case, if signal DGEN is low, the degaussing function circuits are turned off completely.

A thin film head is degaussed, i.e., its remnant bulk magnetization is substantially removed, by applying an alternating current waveform with a progressively decreasing amplitude. The CMOS oscillator 109 produces an alternating current waveform for the write head, and the write current exponential turn-off circuit 113 provides the decreasing current amplitude. Thus, the thin film write head is de-gaussed.

To accommodate the variety of write heads applied in numerous product designs, a programmable oscillator frequency and a programmable number of output current pulses is desirable for the degaussing circuit. The programmable oscillator frequency is produced using a CMOS ring oscillator with switchable feedback paths so that the number of inverters comprising the oscillator can be selectively controlled. The number of output pulses is advantageously determined in the present invention by a programmable timer coupled to a signal indicating the desired number of output pulses. The programmable timer, which may be comprised of a dc current source, a capacitor, and a comparator, is set to a time interval proportional to the number of output pulses. In this manner a circuit can be configured with minimal power and few components to control the number of current pulses applied to the write head. Preferably, the programmable timer is also coupled to the programmable oscillator circuit, wherein the time interval is also set inversely proportional to the oscillator frequency by making the current source proportional to the oscillator frequency. Preferably, the programmable number of degaussing current pulses is set to a number between 3 and 16.

In FIG. 1, the block diagram illustrates a signal source or register 110 which may be configured as a selectively controllable voltage source to indicate the programmable number of output pulses coupled to the programmable timer 111. In addition, a block 112 is also a signal source or register and provides the programmable oscillator frequency which is also coupled to the programmable timer. Thus the CMOS ring oscillator frequency is set by the block 112, and the number of degaussing pulses is determined by the block 111 without the need for a pulse counting arrangement.

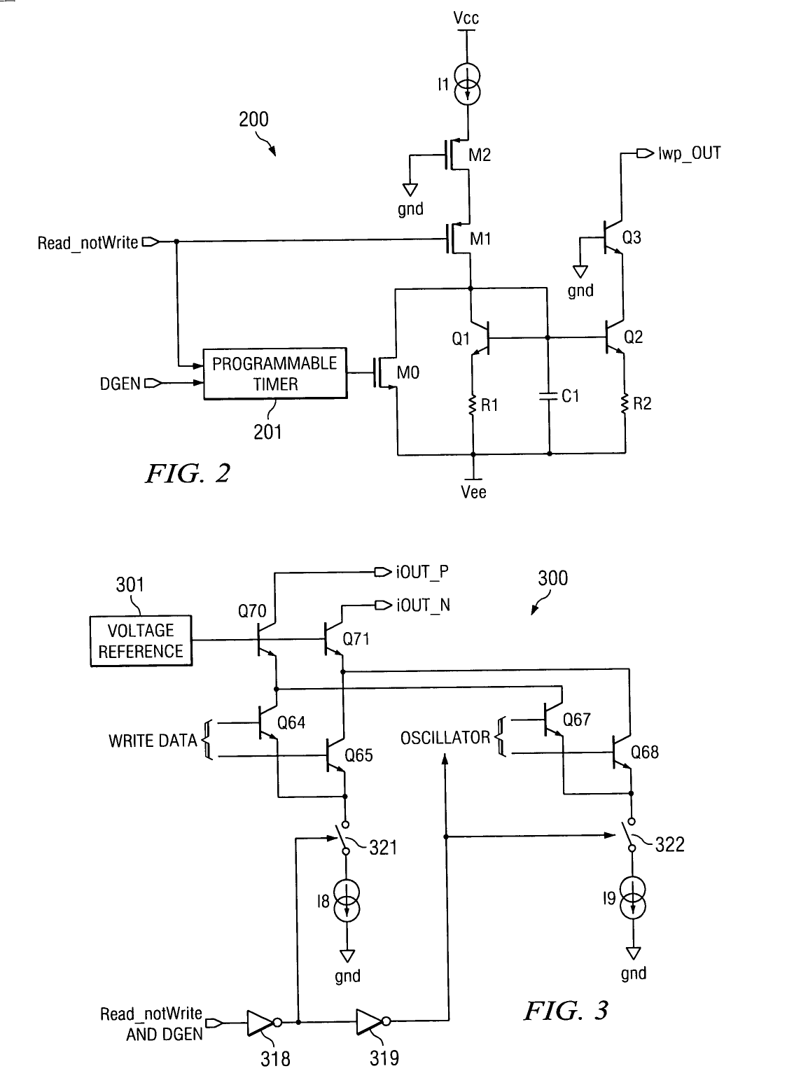

Turning now to FIG. 2, illustrated generally as the circuit 200 of the present invention is a simplified circuit drawing of the write current exponential turn-off block 113 of FIG. 1. Current source I1 produces a current proportional to the write current. The current source I1 is coupled through transistors M2 and M1 to the current mirror comprised of transistors Q1 and Q2 in series with resistors R1 and R2. Capacitor C1 provides a low-pass filtering function for the current mirror, producing the exponential current tail-off when the mirror is disabled. Devices M2 and Q3 are cascode devices to prevent junction breakdown of transistors M0, Q1, and Q2. Transistor M0 switches the write current on and off in response to the delayed Read_notWrite signal and the delayed signal DGEN. During a write-to-read transition, the input signal Read_notWrite goes from low to high (from potential Vee to ground potential gnd; for example, from −5 volts to 0 volts) and the signal DGEN goes high, causing transistor M0 to turn on after the delay provided by the block 201. The current in transistors Q1, Q2, and Q3 decays exponentially depending on the values of the parallel combination of resistors R1 and the capacitor C1. After the delay of, for example, 10-15 ns. in the programmable timer delay block 201 (that is a different programmable timer block than block 111 illustrated in FIG. 1), transistor M0 is turned on and completely disables the current in transistors Q1, Q2, and Q3. This disabling assures that there is no write current in the read operation for the subsequent portion of the data track. The output current from this circuit 200 is provided through transistor Q3, shown as the signal Iwp_OUT, which acts as a current source to the output connection. The signal Iwp_OUT is the signal 121 illustrated on FIG. 1.

Illustrated in FIG. 3 is a simplified circuit implementation of data switching among the blocks Write Data Buffer, I-to-V converter and the CMOS-ECL V-to-I converter (blocks 101, 103, and a portion of block 108 in FIG. 1, respectively). Differential write data current is applied to the bases of transistors Q64 and Q65 which are coupled to the collectors of transistors Q67 and Q68. The differential output signal from the oscillator is applied to the bases of transistors Q67 and Q68. Current is selectively applied to the emitters of transistors Q64 and Q65 or to the emitters of transistors Q67 and Q68 by current mirrors controlled by the signals Read_notWrite and DGEN as described below. The differential output currents from the collectors of either transistors Q64 and Q65 or transistors Q67 and Q68 are coupled to the differential outputs iOUT_P and iOUT_N. The differential outputs iOUT_P and iOUT_N are the switched currents applied to block 103 illustrated in FIG. 1. The base voltage for transistors Q70 and Q71 is provided by a voltage reference 301.

Selection of the output mode of providing write data or a degaussing current waveform for the write head is controlled by the signals Read_notWrite and DGEN. When these signal are high, the circuit is configured so that current source I8 provides current to the transistor pair Q64 and Q65. The inverting buffer 318 enables the switch 321 to conduct, coupling the current source I8 to the emitters of transistors Q64 and Q65.

When the signals Read_notWrite and DGEN are both low, the circuit is configured so that current source I9 provides current to the transistor pair Q67 and Q68. The inverting buffer 319 enables the switch 322 to conduct, coupling the current source I9 to the emitters of transistors Q67 and Q68. Thus the circuit illustrated in FIG. 3 can selectively provide write data or a degaussing current to a write head depending on the control signals Read_notWrite and DGEN.

Shown in FIG. 4 are illustrative waveforms of the write degauss function WRD, write data WD, and a write gate signal WG, which is the Read_notWrite signal inverted. The waveform WD alternates between low and high levels corresponding to the data to be recorded. A representative data sequence 11001001 is illustrated corresponding to the indicated flux transitions. The write gate signal WG is high during the time that write data is supplied. After completion of the write operation, the WG signal goes low and the write degauss signal WRD is shown with alternating amplitude and a number of pulses controlled by a programmable timer such as the timer 111 illustrated in FIG. 1.

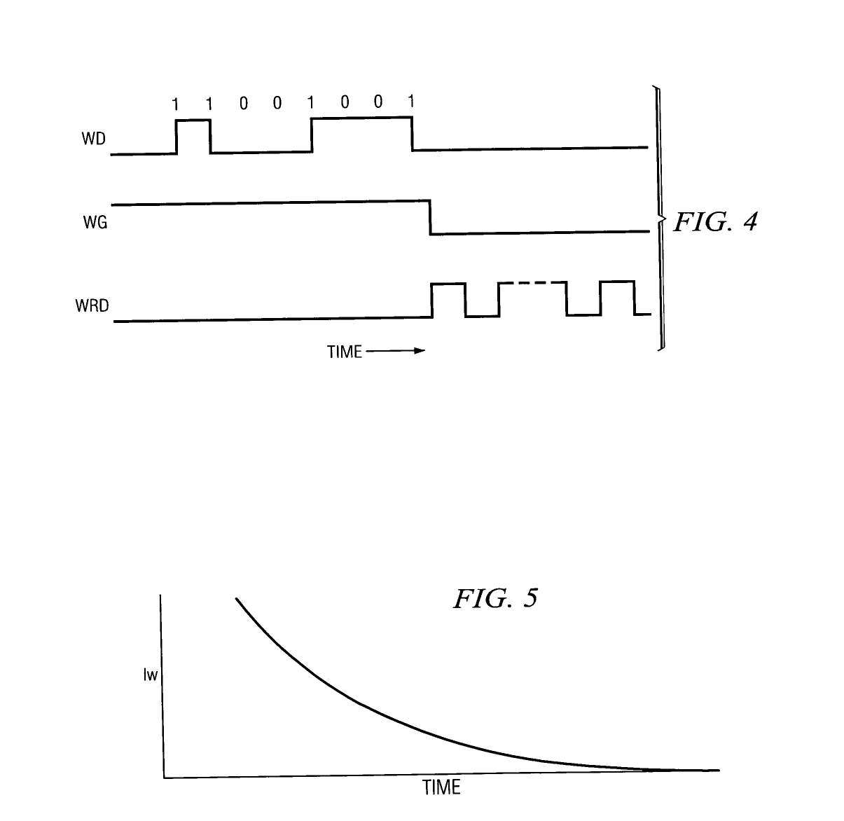

Shown in FIG. 5 is an illustrative shape of a typical write current output decay waveform provided during degauss by a write current exponential turn-off circuit such as the circuit represented by block 113 in FIG. 1. The initial current amplitude is often of the order of 40 to 50 mA, and the decay time constant is often of the order of 10 to 15 ns.

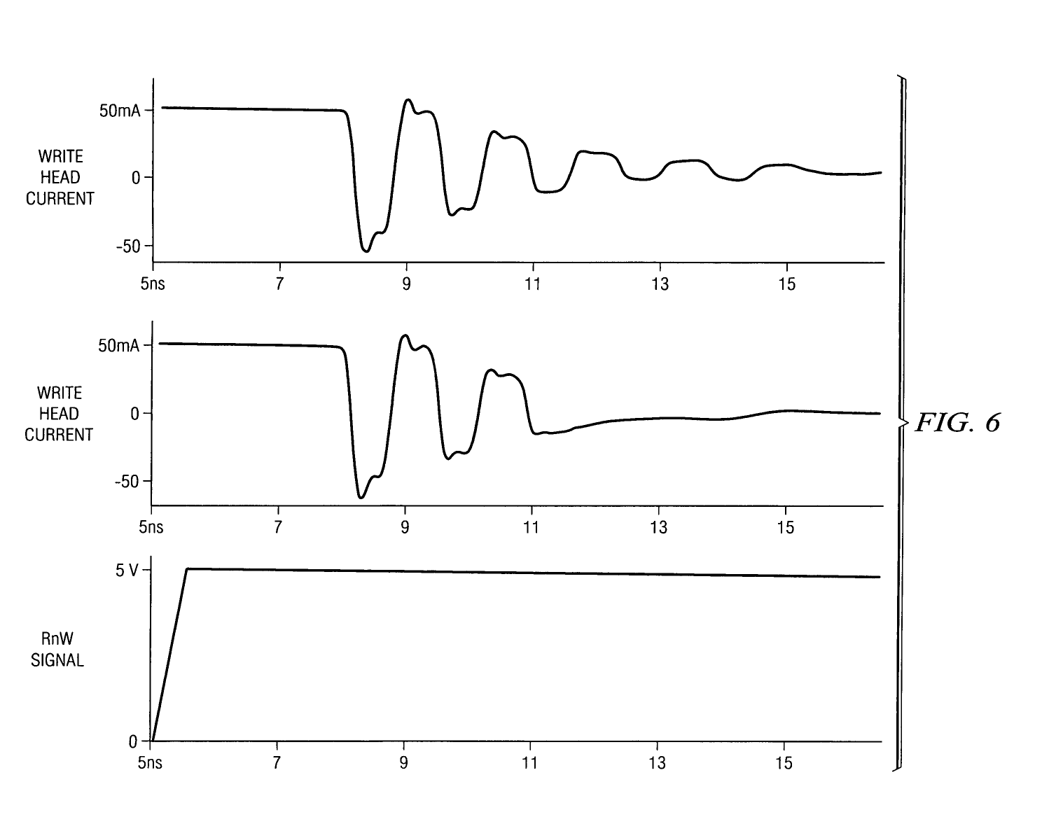

FIG. 6 shows the result of circuit simulations. The top and middle traces represent alternating and decaying write head current from two simulations, with the top trace representing current with more current pulses as controlled by the programmable timer 111 illustrated in FIG. 1. The bottom trace represents the Read_notWrite signal.

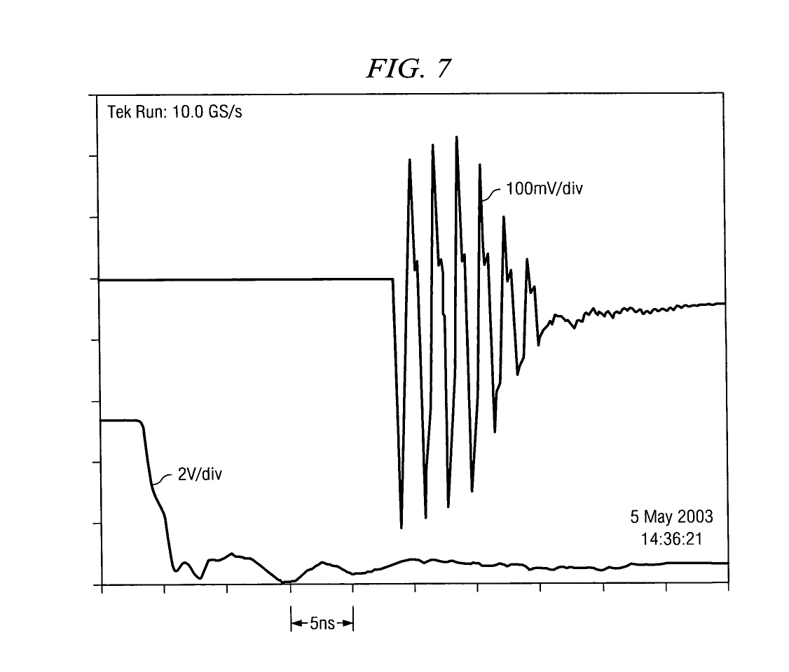

FIG. 7 shows a laboratory measurement of write head current. The top trace is write head current during degauss using the method of the invention. The bottom trace is the Read_notWrite signal. The hard disk drive was arranged for a data rate of 1.5 Gb/s, or one bit per 0.66 ns. In this example, the oscillator controlling degauss is set to a frequency of approximately 0.55 GHz which provides a zero crossing roughly every 0.9 ns as indicated in the figure. Other frequencies may be used as described above.

Although embodiments of the present invention and its advantages have been described in detail, it should be understood that various changes, substitutions and alterations can be made herein without departing from the spirit and scope of the invention as defined by the appended claims. For example, it will be readily understood by those skilled in the art that the circuits and circuit elements described herein may be implemented using various integrated circuit technologies or may be configured using discrete components while remaining within the scope of the present invention.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A write current circuit for a magnetic data storage device, comprising:
a write head drive circuit adapted to selectively drive a write head with a write head degaussing current, wherein the write head degaussing current is an alternating current waveform with a programmable number of current pulses with decreasing amplitude and a frequency controlled by an oscillator; and
a programmable timer, wherein the programmable timer is configured to terminate the write head degaussing current after an interval of time based on a signal indicating the programmable number of current pulses.

2. The write current circuit according to claim 1, wherein the write head is selectively driven with a current signal representing data to be stored in the magnetic data storage device.

3. The write current circuit according to claim 1, wherein the interval of time is dependent on the frequency of the oscillator.

4. The write current circuit according to claim 1, wherein the oscillator is a CMOS ring oscillator with at least one switchable feedback path that controls the oscillator frequency.

5. The write current circuit according to claim 1, wherein the amplitude of the write head degaussing current is controlled with a substantially exponentially decreasing current waveform.

6. The write current circuit according to claim 1, wherein the write head degaussing current is applied at the end of a write cycle.

7. The write current circuit according to claim 1, including means for applying the write head degaussing current at the end of a write cycle.

8. A method of configuring a write current circuit for a magnetic data storage device, comprising:
selectively driving a write head with a write head degaussing current that is an alternating current waveform with a programmable number of current pulses with decreasing amplitude and frequency controlled by an oscillator; and
terminating the write head degaussing current with a programmable timer that responds after an interval of time based on a signal indicating the programmable number of current pulses.

9. The method according to claim 8, including selectively driving the write head with a current signal representing data to be stored in the magnetic data storage device.

10. The method according to claim 8, including setting the interval of time dependent on the frequency of the oscillator.

11. The method according to claim 8, including using a CMOS ring oscillator for the oscillator, and using at least one switchable feedback path in the CMOS ring oscillator to control its frequency.

12. The method according to claim 8, including using a substantially exponentially decreasing current waveform to control the amplitude of the write head degaussing current.

13. The method according to claim 8, including applying the write head degaussing current at the end of a write cycle.

14. A write current circuit for a magnetic data storage device, comprising:
means for selectively driving a write head with a write head degaussing current that is an alternating current waveform having a programmable number of current pulses with decreasing amplitude, the alternating current waveform having a frequency; and
means for terminating the alternating current waveform after an interval of time dependent on the programmable number of current pulses.

15. The write current circuit according to claim 14, including means for selectively driving the write head with a current signal representing data to be stored in the magnetic data storage device.

16. The write current circuit according to claim 14, including means for setting the interval of time dependent on the frequency of the alternating current waveform.

17. The write current circuit according to claim 14, including means for controlling the frequency of the alternating current waveform.

18. The write current circuit according to claim 14, including means for controlling the amplitude of the alternating current waveform with a substantially exponentially decreasing waveform.

19. The write current circuit according to claim 14, including means for applying the write head degaussing current at the end of a write cycle.
